(19) United States
(12) Patent Application Publication
(10) Pub. No.: US 2022/0026886 A1
(43) Pub. Date: Jan. 27, 2022

(54) TASK ASSISTANCE DEVICE, TASK ASSISTANCE METHOD, AND RECORDING MEDIUM

(71) Applicant: Panasonic Intellectual Property Management Co., Ltd., Osaka (JP)

(72) Inventors: Naoko MURAKAMI, Kyoto (JP); Tadao YOKOTA, Osaka (JP)

(21) Appl. No.: 17/311,059

(22) PCT Filed: Dec. 23, 2019
(86) PCT No.: PCT/JP2019/050437

§ 371 Date: Jun. 4, 2021

(51) Int. Cl. G05B 19/418; B25B 23/147; B23P 19/06

(52) U.S. Cl. CPC G05B 19/4187; G05B 19/4183; B23P 19/066; B25B 23/147

(57) ABSTRACT

A task assistance device assists a worker who performs tasks by a predetermined task procedure, the tasks including: a first task with a first driver that is state-switchable between usable and unusable; and a second task performed by the worker without the first driver. The task assistance device includes: a communicator that obtains a start signal indicating a start and an end signal indicating an end of each task; a generator that generates a first control signal that makes the first driver usable when the communicator obtains the start signal of the first task and/or the end signal of the second task, and generates a second control signal that makes the first driver unusable when the communicator obtains at least one of the end signal of the first task or the start signal of the second task; and a communicator that outputs the first control signal and the second control signal generated by the generator to the first driver.

### TECHNICAL FIELD

The present invention relates to a task assistance device, a task assistance method, and a program.

### BACKGROUND ART

Monitoring devices have been developed to prevent a worker from forgetting screw fastening or from insufficiently fastening a screw during a task of screwing a workpiece with a tool (such as a driver). For example, a screw-fastening monitoring device capable of detecting inadequate screw fastening on the basis of the number of turns of a screw is disclosed (see Patent Literature [PTL] 1, for example).

### CITATION LIST

### Patent Literature

[PTL 1] Japanese Unexamined Patent Application Publication No. 2000-176850

### SUMMARY OF INVENTION

### Technical Problem

A worker may perform a plurality of tasks including a task performed with a tool and a task performed without the tool. If the worker makes an error by performing two tasks by an incorrect procedure, the method disclosed in PTL 1 is incapable of detecting this error unfortunately. More specifically, the method disclosed in PTL 1 is incapable of preventing a task error from occurring.

In response to this, the present invention provides a task assistance device, a task assistance method, and a program that are capable of preventing a task error from occurring when a worker performs a task with a tool and a task without the tool.

### Solution to Problem

In accordance with an aspect of the present disclosure, a task assistance device assists a worker who performs a plurality of tasks by a predetermined task procedure, the plurality of tasks including: a first task performed by the worker with a first tool that is state-switchable between usable and unusable; and a second task performed by the worker without the first tool, and the task assistance device includes: an obtainer that obtains a start signal indicating a start and an end signal indicating an end, for each of the plurality of tasks; a generator that generates a first control signal that makes the first tool usable when the obtainer obtains at least one of the start signal of the first task or the end signal of the second task, and generates a second control signal that makes the first tool unusable when the obtainer obtains at least one of the end signal of the first task or the start signal of the second task; and an output unit that outputs the first control signal and the second control signal generated by the generator to the first tool.

In accordance with another aspect of the present disclosure, a task assistance method of assisting a worker who performs a plurality of tasks by a predetermined task procedure, the plurality of tasks including: a task performed by the worker with a tool that is state-switchable between usable and unusable; and a task performed by the worker without the tool, the task assistance method includes: obtaining a start signal indicating a start and an end signal indicating an end, for each of the plurality of tasks; generating a first control signal that makes the tool usable when at least one of the start signal of the task performed with the tool or the end signal of the task performed without the tool is obtained in the obtaining, and a second control signal that makes the tool unusable when at least one of the end signal of the task performed with the tool or the start signal of the task performed without the tool is obtained in the obtaining; and outputting the first control signal and the second control signal generated in the generating to the tool.

In accordance with a still another aspect of the present disclosure, a program causes a computer to execute the task assistance method described above.

General or specific aspects of the present disclosure may be implemented to a system, a method, an integrated circuit, a computer program, a computer-readable recording medium such as a Compact Disc-Read Only Memory (CD-ROM), or any given combination thereof.

### Advantageous Effects of Invention

A task assistance device, a task assistance method, and a program according to an aspect of the present invention are capable of preventing a task error from occurring when a worker performs a task with a tool and a task without the tool.

### BRIEF DESCRIPTION OF DRAWINGS

FIG. 1 is a block diagram illustrating a functional configuration of a task instruction system according to Embodiment.

FIG. 2 illustrates an example of a task table stored in a memory of a task instruction device according to Embodiment.

FIG. 3A is a first diagram illustrating a basic operation performed by the task instruction device according to Embodiment.

FIG. 3B is a second diagram illustrating a basic operation performed by the task instruction device according to Embodiment.

FIG. 3C is a third diagram illustrating a basic operation performed by the task instruction device according to Embodiment.

FIG. 3D is a fourth diagram illustrating a basic operation performed by the task instruction device according to Embodiment.

FIG. 4 illustrates a task instruction image generated according to Embodiment.

FIG. 5 is a sequence diagram illustrating an operation performed by the task instruction system according to Embodiment.

FIG. 6 is a flowchart illustrating an example of an operation performed by the task instruction device according to Embodiment.

FIG. 7 is a flowchart illustrating another example of an operation performed by the task instruction device according to Embodiment.

### DESCRIPTION OF EMBODIMENTS

Hereinafter, certain exemplary embodiments will be described in detail with reference to the accompanying Drawings. The following embodiments are general or specific examples of the present disclosure. The numerical values, shapes, materials, elements, arrangement, and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

It should be noted that the respective figures are schematic diagrams and are not necessarily precise illustrations. Additionally, components that are essentially the same share like reference signs in the figures. Accordingly, overlapping explanations thereof are omitted or simplified.

### Embodiment

### [1. Configuration of Task Instruction System]

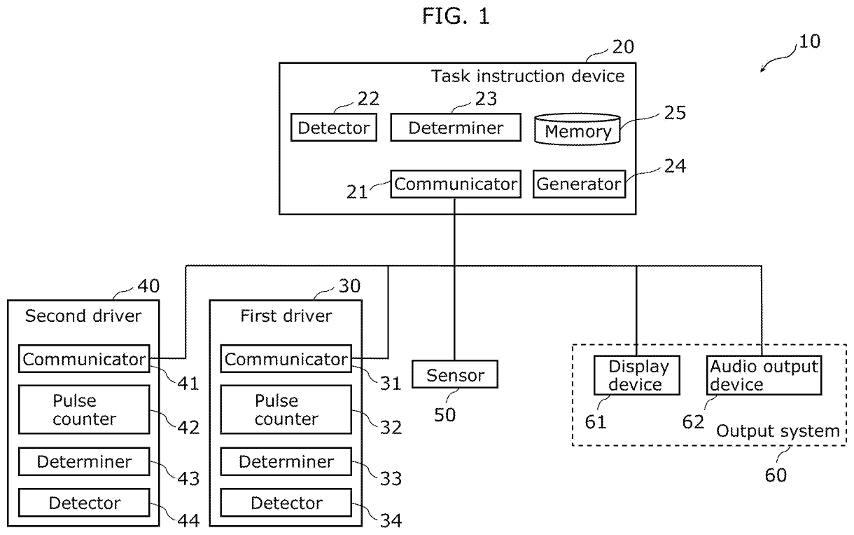

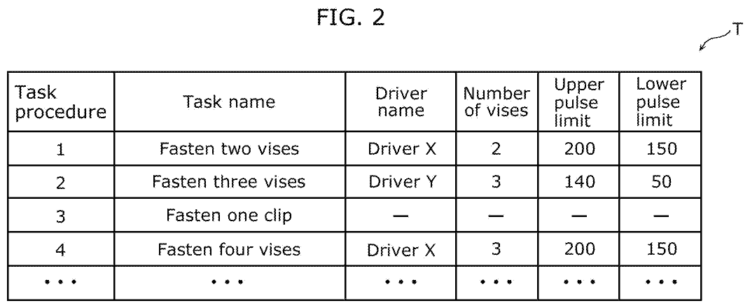

A configuration of a task instruction system according to Embodiment is first described with reference FIG. 1 and FIG. 2. FIG. 1 is a block diagram illustrating a functional configuration of task instruction system 10 according to Embodiment.

As illustrated in FIG. 1, task instruction system 10 includes task instruction device 20, first driver 30, second driver 40, sensor 50, display device 61, and audio output device 62. The following describes a case where task instruction system 10 includes two tools (first driver 30 and second driver 40). However, task instruction system 10 may include at least one tool. Display device 61 and audio output device 62 are included in output system 60. Each of first driver 30 and second driver 40 may also be referred to simply as “the driver” if no distinction is drawn between first driver 30 and second driver 40.

Task instruction device 20 is a server device that enables, for example: task error prevention; learning assistance; compliance with task time; task improvement; and notification about a task error. Basic operations performed by task instruction device 20 are described later. For a worker who performs, for example, a single-worker assembly task in which a plurality of tasks are performed by this worker alone, task instruction device 20 according to Embodiment provides a task instruction and detects a task error for instance. Here, the plurality of tasks performed by the worker include a task performed with a tool (such as a driver) and a task performed without the tool. Task instruction device 20 is an example of a task assistance device.

Task instruction device 20 includes communicator 21, detector 22, determiner 23, generator 24, and memory 25.

Communicator 21 is a communication interface that is communicably connected to various devices included in task instruction system 10 via wireless or wire communication. Communicator 21 obtains a start signal indicating a start and an end signal indicating an end, for each of the plurality of tasks. For example, communicator 21 may obtain at least one of the start signal or the end signal from each of first driver 30 and second driver 40. Alternatively, communicator 21 may obtain at least one of the start signal or the end signal from an operation performed by the worker (such as an operation performed on a button or a footswitch), for example.

Moreover, from sensor 50 that senses a task performed without the tool (an example of a second task), communicator 21 may further obtain a result of the sensing performed on this toolless task. Communicator 21 functions as an obtainer that obtains the start signal indicating the start and the end signal indicating the end for each of the plurality of tasks. Here, the toolless task is performed without any tool used in any of the plurality of tasks. Examples of the toolless task include tasks performed by hand, such as washer insertion, clip fastening, and inspection.

Communicator 21 also functions as an output unit that outputs a signal generated by generator 24 (first to fourth control signals described later, for example) to first driver 30 and second driver 40.

Detector 22 is a processor that detects whether the drivers and the sensor to be used in the plurality of tasks are communicably connected to task instruction device 20. Detector 22 according to Embodiment detects whether first driver 30, second driver 40, and sensor 50 are communicably connected to task instruction device 20. Moreover, detector 22 may detect whether display device 61 and audio output device 62 are communicably connected to task instruction device 20.

Detector 22 performs the detection described above before the worker starts the plurality of tasks. If all of the drivers and the sensor are communicably connected, detector 22 may cause output system 60 to present an output indicating so, for example. If at least one of the drivers or the sensor is not communicably connected, detector 22 may cause output system 60 to present an output indicating so, for example. Note that information about the drivers and the sensor to be used in the plurality of tasks is stored in memory 25, for example (see FIG. 2 described later).

Determiner 23 is a processor that makes various determinations in task instruction device 20. For example, on the basis of information obtained from a driver about screw fastening performed by this driver (such as information including at least one of information indicating the number of turns or information indicating torque), determiner 23 determines whether a task performed by the worker with the driver is completed. Here, the information indicating the number of turns may indicate the number of turns or the number of pulses.

Determiner 23 determines whether a first task of fastening a first screw with first driver 30 is completed, by comparing a first reference number of turns with a first number of turns of first driver 30. Here, the first reference number of turns is the number of turns of first driver 30 (such as the number of turns of the first screw) that indicates completion of fastening of the first screw. The first number of turns of first driver 30 is based on the screw fastening information obtained from first driver 30. This comparison made by determiner 23 between the first reference number of turns and the first number of turns includes: comparison between the numbers of turns as they are; and comparison between the numbers of pulses. The screw fastening information is an example of status information. Fastening of the first screw by first driver 30 is an example of first screw fastening.

More specifically, if the first reference number of turns indicates a range of the number of turns and the first number of turns is within the first reference number of turns, determiner 23 determines that the fastening of the first screw is completed. If the first reference number of turns designates a lower limit and the first number of turns is more than the first reference number of turns, determiner 23 determines that the fastening of the first screw is completed.

For example, determiner 23 functions as a first determiner that obtains, from first driver 30, status information indicating a status of the first task (an example of first status information) and that determines on the basis of the obtained status information whether the first task is completed. The end signal may indicate that determiner 23 of task instruction device 20 determines that the first task is completed, for example. Generator 24 obtains this signal as the end signal. A screw is an example of a fastener member to be fastened by the driver.

Determiner 23 determines that a third task in which a second screw is fastened with second driver 40 is completed, by comparing a second reference number of turns (or upper and lower limit numbers of pulses) with a second number of turns of second driver 40. Here, the second reference number of turns is the number of turns of second driver 40 (such as the number of turns of the second screw) that indicates completion of fastening of the second screw. The second number of turns of second driver 40 is based on the screw fastening information obtained from second driver 40. Fastening of the second screw by second driver 40 is an example of second screw fastening.

More specifically, if the second reference number of turns designates a range of the number of turns and the second number of turns is within the second reference number of turns, determiner 23 determines that the fastening of the second screw is completed. If the second reference number of turns designates a lower limit and the second number of turns is more than the second reference number of turns, determiner 23 determines that the fastening of the second screw is completed.

Note that the first task, the second task, and the third task described above are included in the plurality of tasks.

For example, determiner 23 functions as the first determiner that further obtains, from second driver 40, status information indicating a status of the third task (an example of second status information) and that determines on the basis of the obtained status information whether the third task is completed. The end signal may indicate that determiner 23 of task instruction device 20 determines that the third task is completed, for example. Generator 24 obtains this signal as the end signal.

Assume that the reference number of turns designates the range of the number of turns as described above. In this case, if the number of turns made by the driver exceeds the upper limit of the reference number of turns, task instruction device 20 is capable of detecting placement failure of a predetermined component (such as an error of not inserting a washer) or an error of picking up an incorrect kind of screw, for example. If the number of turns made by the driver is less than or equal to the reference number of turns, task instruction device 20 is capable of detecting insufficient fastening, for example. Note that information about the first reference number of turns and the second reference number of turns (such as an upper pulse limit and a lower pulse limit illustrated in FIG. 2) is stored in memory 25, for example. The following describes a case where each of the first reference number of turns and the second reference number of turns designates the range of the number of turns.

Determiner 23 may further determine whether the second task, which is a toolless task, is completed, on the basis of a result of sensing received from sensor 50. For example, when the toolless task is picking up a predetermined component (such as a washer), determiner 23 may obtain information about a position of a hand of the worker as the result of the sensing and then determine on the basis of the obtained information about the position of the hand of the worker whether the second task is completed. For example, when there are different kinds of washers and washers of each kind are placed in a different container, determiner 23 is capable of determining on the basis of the information about the position of the hand of the worker whether a component to be picked up in the current task is correctly picked up. More specifically, determiner 23 is capable of determining whether the toolless task is completed and whether an error is made in this task. If determining that an error is made in the task, determiner 23 may cause at least one of display device 61 or audio output device 62 to present an output indicating so. Determiner 23 functions as a second determiner that determines whether the toolless task is completed.

Moreover, if another task (a next task, for example) is started before the completion of the current task among the plurality of tasks, determiner 23 may determine that a task procedure is incorrect. For example, if the next operation is started before the end signal of the current task or the start signal of the next task is received, determiner 23 may determine that the task procedure is incorrect.

The above describes a case where task instruction device 20 includes determiner 23. However, this is not intended to be limiting. For example, if each of first driver 30 and second driver 40 has a function of determining whether a task is completed, determiner 23 may not have the function of the first determiner. Moreover, if sensor 50 has a function of determining whether a task is completed, determiner 23 may not have the function of the second determiner, for example.

Generator 24 is a processor that generates a control signal for making first driver 30 and second driver 40 usable or unusable, depending on a task to be performed by the worker. For example, assume that the first task is performed followed by the second task. In this case, if communicator 21 obtains the start signal of the first task, generator 24 generates a control signal (an example of a first control signal) for making only first driver 30 usable out of first driver 30 and second driver 40. If communicator 21 obtains the end signal of the first task or the start signal of the second task, generator 24 generates a control signal for making both first driver 30 and second driver 40 unusable (this signal is an example of a second control signal).

For example, assume that the second task is performed followed by the first task. In this case, if communicator 21 obtains the end signal of the second task, generator 24 generates a control signal (an example of the first control signal) for making only first driver 30 usable out of first driver 30 and second driver 40. If communicator 21 obtains the start signal of the second task, generator 24 generates a control signal for making both first driver 30 and second driver 40 unusable (this signal is an example of the second control signal).

The first control signal enables the driver to operate, or more specifically, enables a motor included in the driver to operate. The second control signal disables the driver from operating, or more specifically, disables the motor included in the driver from operating. The second control signal may be outputted only to first driver 30, for example. Regardless of the driver used in the first task, the second control signal may make all the drivers unusable. The second control signal may be outputted to all the drivers including first driver 30.

If a plurality of drivers are to be used, generator 24 performs control to make only a driver to be used in a next task usable. This prevents the worker from mistakenly using a driver that is not to be used in the task, when the tasks are performed with plurality of drivers.

If task instruction system 10 includes only first driver 30 and communicator 21 obtains at least one of the start signal of the first task or the end signal of the second task, generator 24 generates the first control signal for making first driver 30 usable. Also in this case, if communicator 21 obtains at least one of the end signal of the first task or the start signal of the second task, generator 24 generates the second control signal for making first driver 30 unusable. For example, if at least one of the start signal or the end signal is received from first driver 30, generator 24 generates at least one of the first control signal or the second control signal.

Assume that the second task is performed followed by the third task. In this case, if communicator 21 obtains at least one of the start signal of the third task or the end signal of the second task, generator 24 generates a control signal (an example of a third control signal) for making only second driver 40 usable out of first driver 30 and second driver 40. If communicator 21 obtains the end signal of the third task, generator 24 generates a control signal for making both first driver 30 and second driver 40 unusable (this signal is an example of a fourth control signal). For example, communicator 21 may obtain at least one of the start signal or the end signal of the third task from second driver 40. Moreover, generator 24 may obtain at least the end signal of the third task from determiner 23. The third control signal enables the driver to operate, for example. The fourth control signal disables the driver from operating, for example.

Assume that the first task, the second task, and the third task are performed in this order. In this case, first driver 30 and second driver 40 do not operate in the second task that is the toolless task. Thus, task instruction device 20 can prevent the worker from forgetting the second task and mistakenly performing the third task after the first task.

Similar to the second control signal, the fourth control signal may be outputted only to second driver 40 or to all the drivers including second driver 40. In Embodiment, the fourth control signal is outputted to both first driver 30 and second driver 40, for example. In other words, communicator 21 outputs the fourth signal to both first driver 30 and second driver 40.

If another task is started before the completion of the current task, generator 24 may further generate a signal to warn the worker. If determiner 23 determines that the task procedure is incorrect, generator 24 generates a warning signal to warn the worker and outputs this signal to output system 60. The warning signal includes information used for issuing a warning to the worker by using at least one of an image or audio. Generator 24 may have a function as a warning issuer that issues a signal to warn the worker.

Memory 25 is a memory device that stores a control program to be executed by the processors (such as detector 22, determiner 23, and generator 24) included in task instruction device 20. Moreover, memory 25 may store the information (such as the first number of turns, the second number of turns, and the result of sensing) obtained via communicator 21. Memory 25 is implemented by a semiconductor memory, for example.

The following describes the information stored in memory 25, with reference to FIG. 2. FIG. 2 illustrates an example of task table T stored in memory 25 of task instruction device 20 according to Embodiment. Note that FIG. 2 illustrates an example of task table T for screw fastening using a vis as an example of a screw. Here, a vis is also referred to as a screw in the description, other than FIG. 2.

As illustrated in FIG. 2, memory 25 stores task table T in which a task step, a task name, a driver name, the number of vises, an upper pulse limit, and a lower pulse limit are associated with one another. Each of task steps 1, 2, and 4 is an example of a task performed with a driver. Task step 2 is an example of a task performed without a driver. In other words, task table T is used for a plurality of tasks including a task performed with a driver and a task performed without a driver. Note that the number of tasks performed with or without a driver and the order in which these tasks are performed are not intended to be particularly limiting. The task performed with the driver is an example of a task performed with a tool that is state-switchable between usable and unusable. The task performed without the driver is an example of a task performed without this tool.

Each task step indicates an ordinal number of this step in the task procedure of the plurality of tasks performed by the worker. The task procedure is predetermined. The example in FIG. 2 illustrates that task steps 1, 2, 3, and 4 are performed in this order.

Each task name describes task details, and is specified for each of the plurality of tasks. A glance at the task name allows the worker to know details of a next task.

Each driver name indicates a name used by the worker to identify the driver, and is specified for each of the drivers. The driver name may be any name that can be identified by the worker, and thus may be a model number of the driver for instance.

The number of vises indicates the number of vises to be used in vis-fastening in the task.

Each of the upper and lower pulse limits is a pulse count referenced by determiner 23 to determine on the basis of the status information whether the task performed with the driver is completed. For example, each of the upper and lower pulse limits may be determined on the basis of the numbers of turns (or pulse counts) made by a plurality of workers to appropriately complete the vis fastening in the vis fastening task (the screw fastening task). For example, each of the upper and lower pulse limits may be determined on the basis of the number of turns more than or equal to a predetermined number of turns (the greatest number of turns, for example) and the number of turns smaller than or equal to a predetermined number of turns (the smallest number of turns, for example) among all the numbers of turns made by the plurality of workers. This allows a task manager to appropriately specify the upper and lower pulse limits even if the number of turns made to appropriately complete the screw fastening in the screw fastening task is different for each of the plurality of workers.

Task table T may include at least one of the upper pulse limit or the lower pulse limit. If the status information includes information about torque, task table T may include at least one of an upper torque limit or a lower torque limit. If the driver determines whether the task is completed, task table T may not include the information about the upper and lower pulse limits.

As illustrated, task step 1 is fastening two vises with driver X. Driver X is first driver 30, for example. For vis fastening with driver X, each of the upper and lower pulse limits is a reference value used for determining whether the fastening of the vis is completed. Each of the upper and lower pulse limits is a numerical value corresponding to the number of turns of the vis. Task step 1 is an example of the first task.

As illustrated, task step 2 is an example of a task performed with a driver different from the driver used in task step 1. Task step 2 is an example of the third task.

As illustrated, task step 3 is an example of a task of fastening one clip. Task step 3 is an example of the second task.

As illustrated, task step 4 is an example of a task performed with the same driver as used in task step 1.

As described above, task instruction device 20 holds the information (task table T) that allows the worker to perform the plurality of tasks including the task performed with the driver (such as the screw fastening) and the task performed without the driver, by the predetermined task procedure.

Referring back to FIG. 1, each of first driver 30 and second driver 40 is a tool used by the worker in a task performed with the tool, and is an example of the tool that is state-switchable between usable and unusable. Note that the tool described here is an electric tool that is operable by power. Here, power is electricity or air, for example. For example, first driver 30 is a fastening tool used to fasten the first screw, and is an example of a first tool. Second driver 40 is a fastening tool different from first driver 30. For example, second driver is a fastening tool used to fasten the second screw different from the first screw, and is an example of a second tool. Note that the number of drivers and the kinds of drivers that are connected to task instruction device 20 are not intended to be particularly limiting. A configuration of second driver 40 is the same as that of first driver 30 and thus omitted from the description. To be more specific, communicator 41, pulse counter 42, determiner 43, and detector 44 are the same as communicator 31, pulse counter 32, determiner 33, and detector 34, respectively.

First driver 30 includes communicator 31, pulse counter 32, determiner 33, and detector 34.

Communicator 31 is a communication interface that is communicably connected to task instruction device 20 via wireless or wire communication. For example, communicator 31 obtains the various control signals (the first to fourth control signals, for example) from task instruction device 20. Moreover, communicator 31 output, to task instruction device 20, at least one of: a result of counting by pulse counter 32; a result of determination made by determiner 33 whether the task is completed, on the basis of the result of the counting by pulse counter 32; or a result of detection (a result of detection of an increase in torque, for example) by detector 34.

Pulse counter 32 is a processor that counts the number of turns of first driver 30. For example, pulse counter 32 includes a circuit that is built in a motor (not shown) of first driver 30 and capable of counting pulse signals emitted from an encoder (not shown), and detects the number of turns on the basis of the result of counting the pulse signals. A turn of the motor causes the encoder to emit a pulse signal, as a turn signal corresponding to this turn. The number of turns counted by pulse counter 32 is an example of the first number of turns. The number of turns counted by pulse counter 42 is an example of the second number of turns.

Determiner 33 is a processor that determines on the basis of the number of turns counted by pulse counter 32 whether the first screw is fastened. For example, determiner 33 determines whether the first screw is fastened, by comparing the reference number of turns stored in a memory (not shown) or the reference number of turns obtained from task instruction device 20 with the number of turns counted by pulse counter 32. Here, if task instruction device 20 includes determiner 23, first driver 30 may not include determiner 33.

Detector 34 is a processor that detects an increase in torque, a start of turning, and an end of turning. Detector 34 may detect the increase in torque, the start of turning, and the end of turning by measuring electric current consumption of first driver 30.

Regardless of whether first driver 30 includes determiner 33, detector 34 may output the results of detecting the increase in torque, the start of turning, and the end of turning, to task instruction device 20 via communicator 31. As a result of this, the results of detection obtained by first driver 30 and second driver 40 are accumulated in task instruction device 20. The accumulated results of detection are used for analysis and assessment of the screw fastening.

As described above, task instruction device 20 is a task assistance device that assists the worker who performs the plurality of tasks by the predetermined task procedure, the plurality of tasks including: the first task performed with first driver 30 (an example of the first tool) that is state-switchable between usable and unusable; and the second task performed without first driver 30. Cooperation between task instruction device 20 and first driver 30 enables task instruction system 10 including first driver 30 to provide quality assurance of the tasks performed by the worker.

Sensor 50 is provided if sensing is to be performed in the first to third tasks. For example, sensor 50 may include at least one of a camera, a proximity sensor, or a motion sensor. The number of sensors 50 connected to task instruction device 20 is not intended to be particularly limiting. Sensor 50 is provided as appropriate depending on the task details.

Output system 60 outputs information obtained from task instruction device 20. For example, output system 60 includes display device 61 and audio output device 62. More specifically, output system 60 outputs information to the worker using both an image and audio.

Display device 61 outputs, as an image, the information obtained from task instruction device 20. The image includes a photograph, video, an illustration, and words, for example. Display device 61 is a liquid crystal display, for example. The image outputted by display device 61 is viewed by the worker and used for verifying the task details and the result of determination, for example. For example, display device 61 displays at least one of: a task procedure; information identifying a driver to be used (such as a name of the driver); the number of screws to be used in screw fastening; a result of determining the screw fastening; or a task elapsed time. Display device 61 is placed out of the way of the worker performing the task.

Audio output device 62 outputs, as audio, the information obtained from task instruction device 20. Audio output device 62 is a speaker, for example. The audio outputted by display device 61 is listened by the worker and used for verifying the task details and the result of determination, for example. For example, audio output device 62 outputs at least one of: reading out of the task procedure; a sound indicating an OK as a result of determining the screw fastening; or a sound indicating an NG (such as a warning sound) as a result of determining the screw fastening.

Output system 60 may include at least one of display device 61 or audio output device 62. Task instruction system 10 may include, as output system 60, a device like a projector that displays information on an object (a screen, for example). Moreover, task instruction system 10 may include, as output system 60, a device like a light-emitting device that outputs information using light (a color of light, for example).

Assume that output system 60 includes both display device 61 and audio output device 62. In this case, if the worker is to perform a task while gazing in a direction (downward, for example) different from a direction in which display device 61 is placed, task instruction device 20 may output the information to the worker by mainly using audio output device 62. Task instruction device 20 stores task table T illustrated in FIG. 2 and a task instruction image described later. Thus, by reference to at least one of task instruction table T or the task instruction image, task instruction device 20 may cause at least one of display device 61 or audio output device 62 to output the information.

### [2. Basic Operations of Task Instruction System]

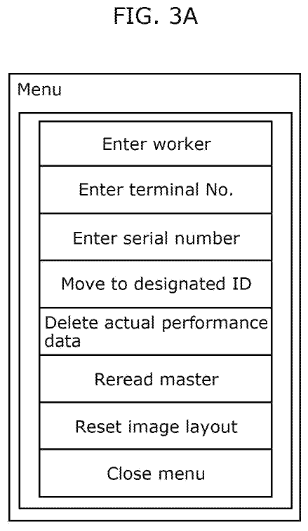

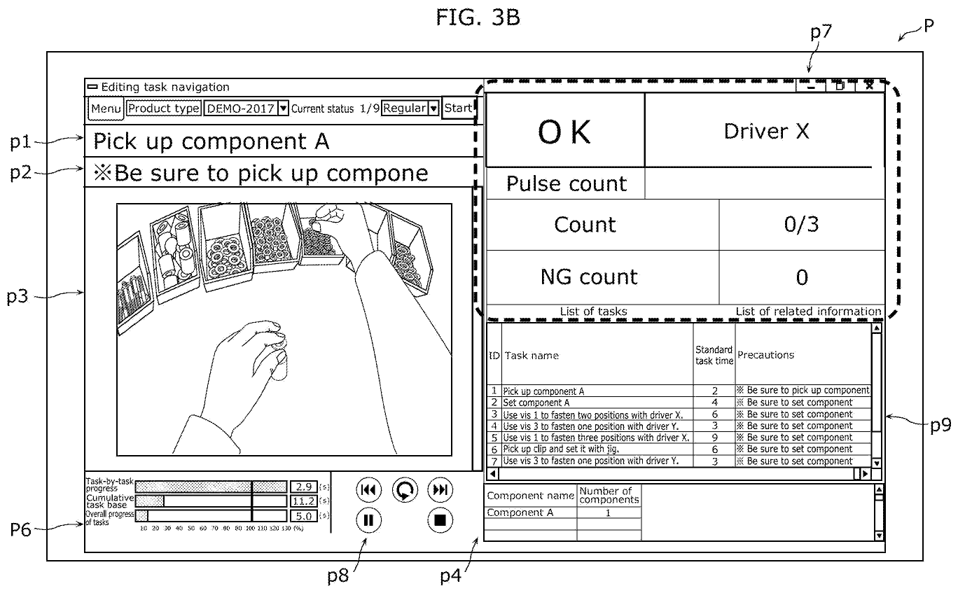

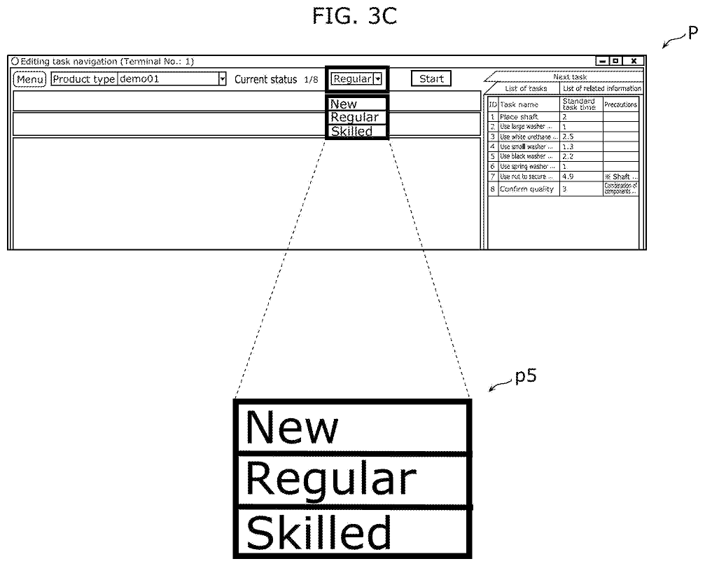

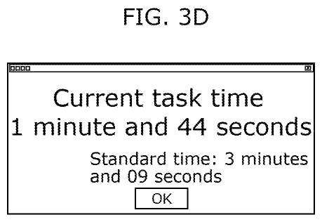

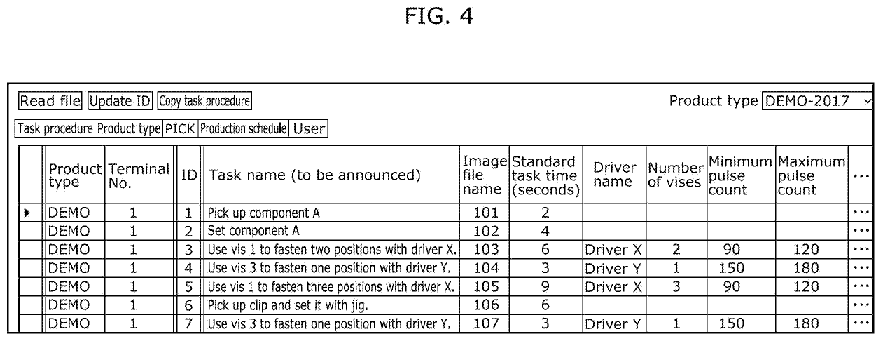

Next, the following describes basic operations of task instruction system 10 described above, with reference to FIG. 3A to FIG. 4. To be more specific, operations performed by task instruction device 20 to provide task instructions to the worker are described. The operations are achieved by the processors of task instruction device 20 that execute a predetermined application program (hereinafter, also referred to as a dedicated application).

A basic operation performed using, for example, a task instruction image stored in memory 25 is first described. FIG. 3A is a first diagram illustrating the basic operation performed by task instruction device 20 according to Embodiment.

As illustrated in FIG. 3A, the worker first starts the dedicated application and enters predetermined information into item fields displayed on a menu. The predetermined information includes information for identifying the worker and a task to be performed by the worker, for example. For example, items displayed on the menu are: “Enter worker” for entering information identifying the worker; “Enter terminal No.” for identifying a task terminal to be used; and “Enter serial number” for entering a number of a product to be worked on. The items displayed on the menu further include an item for managing actual performance data obtained through the task performed in the past and an item for adjusting an image layout.

In response to the entries of the predetermined information, an image corresponding to the task is displayed on display device 61. FIG. 3B is a second diagram illustrating a basic operation performed by task instruction device 20 according to Embodiment. To be more specific, this diagram illustrates task instruction image P displayed on display device 61 by task instruction device 20.

As illustrated in FIG. 3B, task instruction image P is displayed on display device 61 in response to an entry of a product type (“DEMO-2017” is entered in FIG. 3B). Upon receiving an operation from the worker, task instruction device 20 causes display device 61 to display task instruction image P corresponding to this operation. For example, task instruction image P displays: product type; task name p1 (“Pick up component A” in FIG. 3B); precaution p2 for the task (“Be sure to pick up component” in FIG. 3B); description image p3 that describes the task; and component name p4 (“Component A” in FIG. 3B). Although not illustrated, a task instruction corresponding to description image p3 is outputted by voice from audio output device 62. Description image p3 is motion video, for example. Task name p1 (task details), precaution p2, description image p3, and component name p4 are created for each of the plurality of tasks.

Thus, the worker receives a task instruction by means of task instruction image P and voice. Task instruction device 20 is capable of assisting the worker to avoid a task error by presenting: the task instruction using description image p3 and voice; a task instruction using words; and displaying of precaution p2. For example, a skilled worker is able to perform a task according to a voice instruction without looking at description image p3 on display device 61. For example, a worker unskilled in this task is able to proceed with the task smoothly by looking at description image p3 on display device 61 only when necessary. Hence, task instruction device 20 enables task error prevention and learning assistance.

For a task performed with a driver, task name p1 includes the name of the driver to be used, the type of vis, and the number of vises, for example. As an example, task name p1 is displayed as “Use vis 1 to fasten two positions with driver X”.

Moreover, task instruction image P may further display a selection image from which a worker class is selected according to a skill level of the worker. FIG. 3C is a third diagram illustrating a basic operation performed by task instruction device 20 according to Embodiment.

As illustrated in FIG. 3C, selection image p5 from which a worker class of the worker is to be selected is displayed in response to a click on a drop-down menu by the worker for example before the start of the task or during the task. FIG. 3C illustrates an example of displaying three classes, “New”, “Regular”, and “Skilled”. Here, the number of worker classes is not intended to be particularly limiting and may be two or more. As a result of the selection of the worker class made by the worker, the details to be outputted from at least one of display device 61 or audio output device 62 may be changed. For example, as a result of the selection of “New”, task instruction device 20 outputs all the task instructions stored in memory 25. In contrast, as a result of the selection of “Regular” or “Skilled”, task instruction device 20 may not output a task instruction of a predetermined task among the plurality of tasks, for example. This enables the output of task instruction image P appropriate to the skill level of the worker.

Referring back to FIG. 3B, task instruction image P displays elapsed-time indication bar p6. Elapsed-time indication bar p6 displays: bars indicating progress rates of the tasks; and progress times. The progress rate bars indicate: an elapsed time of a task currently being performed (“Task-by-task progress” of an upper bar in elapsed-time indication bar p6); a cumulative sum of standard times of the plurality of tasks (“Cumulative task base” of a middle bar in elapsed-time indication bar p6); and an elapsed time of one cycle of tasks underway (“Overall progress of tasks” of a lower bar in elapsed-time indication bar p6). The standard task time is preset. The plurality of tasks performed by the worker are also referred to as element tasks. The plurality of tasks performed by the worker according to the task procedure corresponds to one cycle. Thus, one cycle of tasks underway indicates that the worker is currently performing the plurality of tasks according to the task procedure.

Check on elapsed-time indication bar p6 allows the worker to verify whether the standard time is complied with. This helps the worker maintain a task pace. Hence, task instruction device 20 is capable of assisting the worker to comply with the task time. If the elapsed time of the task underway exceeds a predetermined percentage of the standard time of this task, task instruction device 20 may alert the worker. For example, task instruction device 20 may alert the worker by changing a color used for the task-by-task progress bar and a color used for the progress time. Alternatively, task instruction device 20 may alert the worker by causing audio output device 62 to output sound. For example, if the elapsed time of the task underway exceeds 70% of the standard time of this task, task instruction device 20 may change the colors used for the task-by-task progress bar and the progress time to an orange color. Moreover, if the elapsed time of the task underway exceeds the standard time of this task, task instruction device 20 may change the colors used for the task-by-task progress bar and the progress time to a red color that further alerts the worker.

If there are different kinds of washers and washers of each kind are placed in a different container as illustrated in description image p3, a container of washers to be picked up by the worker in the current task may be highlighted in description image p3.

Whenever receiving the end signal of the current task or the start signal of a next task, task instruction device 20 causes display device 61 to display task instruction image P corresponding to the next task.

On completion of one cycle of tasks (the plurality of tasks assigned to the worker), task instruction device 20 may cause display device 61 to display a result of the tasks. FIG. 3D is a fourth diagram illustrating a basic operation performed by task instruction device 20 according to Embodiment.

Task instruction device 20 may cause display device 61 to display a task time at the completion of one cycle as illustrated in FIG. 3D. Moreover, task instruction device 20 may further cause display device 61 to display the standard time corresponding to one cycle as well

Referring back to FIG. 3B, for a task performed with a driver, task instruction image P displays actual performance information p7 indicating actual performance of the task performed with the driver, for example. Task instruction image P including actual performance information p7 is displayed when the task with the driver is performed in cooperation with the driver. For example, actual performance information p7 includes: a result of the task (“OK” in the diagram); a driver name to be used in this task (“Driver X” in the diagram); pulse; count; and NG count. For a task performed without a driver, actual performance information p7 may not be displayed.

The result of the task indicates a result of determination whether the vis fastening is successful. For example, whenever determiner 23 determines that the vis is fastened properly or that the vis is not fastened properly, a result of the determination of the vis fastening is displayed as the result of the task. The result of the task is displayed for each vis.

The driver name indicates information for identifying a driver to be used in the task performed with this driver. Only the driver indicated in this field of the driver name is usable.

The pulse indicates an actual pulse count displayed for each vis-fastening task.

The count indicates the number of times determiner 23 determines that the vis is fastened (determines “OK”, for example). To be more specific, the actual number of vises that are determined as “OK” (“0” in the diagram) and the total planned number of vises to be fastened in this task (“3” in the diagram) are displayed as the count.

The NG count is the number of errors in vis fastening. If determiner 23 determines that an error is made in the vis fastening, the NG count is incremented.

Actual performance information p7 displayed as described above allows the worker to verify the actual performance of the task performed with the driver. Moreover, the result of the task and the driver name displayed on display device 61 allows the worker to easily know the result of the task and the information about the driver to be used.

Moreover, task instruction image P displays operation image p8 used for an operation of switching description image p3 for instance. For example, in response of selection of a predetermined button in operation image p8 with a mouse or the like, description image p3 changes according to this button. Operation image p8 includes, for example: a button for pausing description image p3 currently being displayed or resuming description image p3 paused; a button for proceeding to a next task; a button for rewinding to a previous task; and a button for starting or pausing the reading-out of a voice instruction.

Note that, instead of the buttons described above, shortcut keys may be assigned to enable easy operation with a keyboard. Moreover, task instruction system 10 may include a sound pickup device (such as a microphone, although not illustrated). In this case, task instruction device 20 may change the details displayed in task instruction image P, in response to speech of the worker obtained by this sound pickup device.

Thus, the worker can change the details displayed in task instruction image P, according to the progress of the task for example. For instance, redisplaying of a part of description image p3 that was hard to understand leads to prevention of a task error. If the task is completed before an end of description presented by description image p3, the worker can proceed to a next task to smoothly follow the procedure.

Furthermore, task instruction image P may also display information, such as task list p9 that is a list of element tasks of one cycle.

This allows the worker to know information about a task performed before the current task or a task to be performed after the current task.

If receiving at least one of the end signal indicating the end of the current task or the start signal indicating the start of a next task (from the driver or the sensor, for example), task instruction device 20 automatically switches the information to be outputted to output system 60 to information about a next task. For example, task instruction device 20 automatically switches task instruction image P displayed on display device 61 to task instruction image P corresponding to the next task. The automatic switching of task instruction image P by task instruction device 20 is not intended to be limiting. Task instruction image P may be switched in response to an operation performed by the worker (such as an operation performed on the footswitch).

Next, the following describes a procedure by which task instruction device 20 described above creates task instruction image P to be displayed by display device 61. FIG. 4 illustrates task instruction image P generated according to Embodiment. Note that settings in a task table of FIG. 4 are different in value and item from the settings in task table T of FIG. 2, as an example.

As illustrated in FIG. 4, the worker enters information in each item field beforehand. Items include “Product type”, “Terminal No.”, “ID”, “Task name”, “Image file name”, “Standard task time”, “Driver name”, “Number of vises”, “Minimum pulse count”, and “Maximum pulse count”, for example.

“ID” is numerical information specified for each “Task name” to identify this task name. In response to entries of “ID” and “Task name”, task list p9 of task instruction image P is displayed. In response to an entry of “Image file name”, image data corresponding to this image file is displayed as description image p3. For example, description image p3 of FIG. 3B is an image corresponding to the image file name “101”. In response to an entry of “Standard task time”, this information is displayed in elapsed-time indication bar p6 corresponding to the task. In response to entries of “Driver name” and “Number of vises”, this information is displayed in actual performance information p7. In response to entries of “Minimum pulse count” and “Maximum pulse count”, determiner 23 is capable of making a determination on the basis of these pulse values.

As described above, an operation as simple as entering the prescribed information in the item fields illustrated in FIG. 4 enables generation of task instruction image P that assists the worker to perform the task.

As described above, description image p3 is selected and edited for each of the plurality of tasks performed by the worker, so that task instruction image P corresponding to one cycle of the plurality of tasks is created.

### [3. Operation of Task Instruction System]

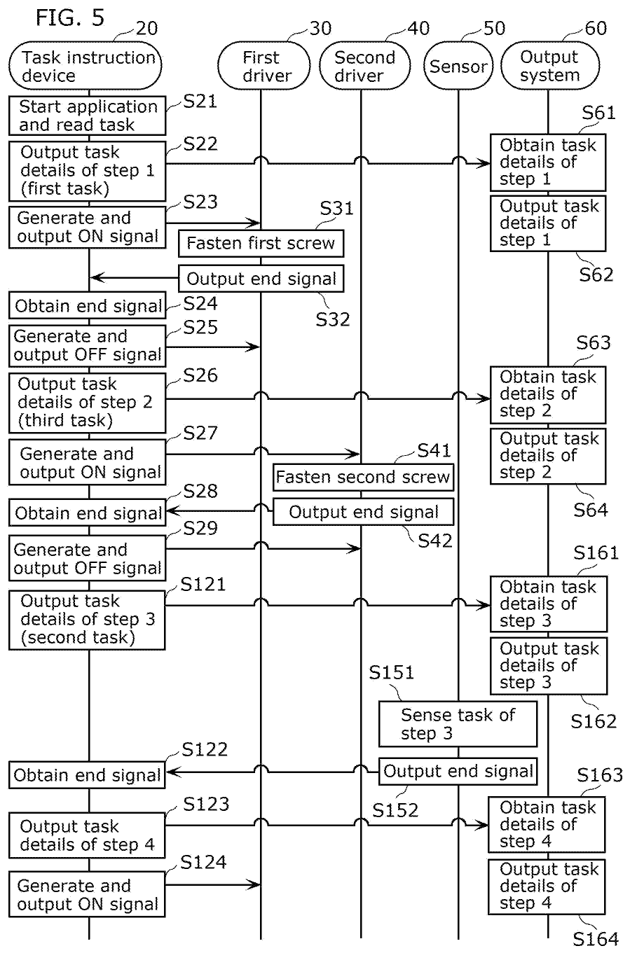

Next, the following describes an operation of task instruction system 10 described above, with reference to FIG. 5 to FIG. 7. To be more specific, the following describes control performed by task instruction device 20 to switch the states of first driver 30 and second driver 40 between usable and unusable. FIG. 5 is a sequence diagram illustrating an operation performed by task instruction system 10 according to Embodiment. Note that FIG. 5 illustrates the operation of task instruction system 10 performed when the plurality of tasks described in task table T of FIG. 2 are performed. Hereinafter, task steps 1 to 4 described in task table T are also referred to as steps 1 to 4. Note also that FIG. 5 mainly illustrates a case of determining whether the task is completed by the driver and the sensor.

As illustrated in FIG. 5, in response to an operation performed by the worker, task instruction device 20 starts the dedicated application and reads the task procedure following the entries of the predetermined information (S21). The entries of “worker” and “serial number” allows task instruction device 20 to determine whether this worker is in charge of the task performed for this serial number. Task instruction device 20 extracts task instruction image P and task table T corresponding to the predetermined information, from among a plurality of task instruction images and a plurality of task tables stored in memory 25. Here, the reading includes reading task instruction image P and task table T from an external recording medium (such as a CD-ROM or a USB memory) of task instruction device 20. Moreover, the reading of the task procedure also includes obtaining task instruction image P and task table T by communicator 21 from an external device via communication.

After the task procedure is read, detector 22 may detect on the basis of task table T whether the driver and the sensor to be used in the task are connected, for example. Moreover, detector 22 may also cause output system 60 to output the result of the detection. The following describes an operation performed by task instruction device 20 if detector 22 detects that the driver and the sensor to be used in the task are all connected.

Next, task instruction device 20 outputs task details described as step 1 to output system 60 (S22). To be more specific, task instruction device 20 outputs task instruction image P corresponding to the task details described as step 1, to output system 60 via communicator 21. A task of step 1 is an example of the first task.

At this time, task instruction device 20 may output a signal for making first driver 30 and second driver 40 unusable (hereinafter, this signal is also referred to as an OFF signal). More specifically, generator 24 generates the OFF signal and outputs this OFF signal to both first driver 30 and second driver 40 via communicator 21.

For example, the OFF signal may be outputted to disable first driver 30 and second driver 40 even if first driver 30 and second driver 40 receive an operation from the worker (such as a press of a button to activate the driver). Alternatively, the OFF signal may disable reception of an operation from the worker (by locking the button to prevent the press, for example). Moreover, the OFF signal may stop supply of power (such as electricity or air) to actuate first driver 30 and second driver 40, for example. Alternatively, if first driver 30 and second driver 40 are contained in a container stand, the OFF signal may keep first driver 30 and second driver 40 from being taken out of the container stand.

The OFF signal may be any signal other than the aforementioned signals if this signal prevents the worker from using first driver 30 and second driver 40. The following describes a case where the OFF signal disables the driver even if this driver receives an operation from the driver.

Output system 60 obtains the task details of step 1 from task instruction device 20 (S61), and then outputs the obtained task details of step 1 (S62). Output system 60 outputs the task details of step 1 to the worker using at least one of an image or audio. At least one of viewing or listening to the task details of step 1 outputted from output system 60 enables the worker to understand the task details of the first task, for example.

Next, task instruction device 20 generates an ON signal to enable first driver 30 that is to be used in the first task and then outputs this ON signal (S23). To be more specific, generator 24 generates the ON signal to enable the driver and outputs this ON signal via communicator 21. In Step S23, the ON signal is outputted only to first driver 30 out of first driver 30 and second driver 40. More specifically, the ON signal is not outputted to second driver 40 in Step S23 and thus second driver 40 remains unusable while step 1 is being performed (during the first task). The ON signal outputted in Step S23 is an example of the first control signal.

For example, if one of first driver 30 and second driver 40 receives an operation from the worker (with a press of the button activating the driver), the ON signal causes the driver to be actuated in response to this operation. The ON signal may enable the supply of power (such as electricity or air) to actuate the one of first driver 30 and second driver 40, for example. If first driver 30 and second driver 40 are contained in a container stand, the ON signal may allow the one of first driver 30 and second driver 40 to be taken out of the container stand.

The ON signal may be any signal other than the aforementioned signals if this signal allows the worker to use the one of first driver 30 and second driver 40. The present embodiment describes a case where if the driver receives an operation from the worker, the ON signal actuates the driver in response to this operation (that is, cancels the state caused by the OFF signal). Generator 24 outputs the ON signal only to first driver 30.

Note that task instruction device 20 may output the ON signal concurrently with or after Step S22. Task instruction device 20 may output the ON signal concurrently with the output of the task details of step 1. Alternatively, task instruction device 20 may output the ON signal if obtaining information indicating that the worker understands the task details by the output from output system 60 (such as a signal, an example of the start signal, indicating an operation performed on the footswitch).

Obtaining the ON signal, first driver 30 becomes usable. In response to an operation of the worker, first driver 30 fastens the first screw (S31). At this time, second driver 40 is unusable and thus the worker is unable to mistakenly fasten the second screw with second driver 40 in Step S31.

Pulse counter 32 counts the number of turns made by first driver 30 in the fastening of the first screw. Then, if the number of turns counted by pulse counter 32 is within the first reference number of turns corresponding to the first screw, determiner 33 determines that the first screw is fastened. For example, a plurality of first screws are fastened in the first task, determiner 33 makes this determination about the number of turns for each of the plurality of first screws. If determining that the number of turns is within the first reference number of turns for each of the plurality of first screws, determiner 33 determines that the first screws are fastened. More specifically, if all the numbers of turns of the plurality of first screws (two first screws in the example illustrated in FIG. 2) used in the first task are within the first reference number of turns, determiner 33 determines that the first task is completed.

If determining that the first task is completed, determiner 33 outputs an end signal indicating that the first task is completed, to task instruction device 20 via communicator 31 (S32). The end signal may include results of detection of an increase in torque, a start of turning, and an end of turning detected by detector 34.

If obtaining the end signal from first driver 30 (S24), task instruction device 20 generates the OFF signal to make first driver 30 unusable and then outputs this signal (S25). To be more specific, if obtaining the end signal via communicator 21, generator 24 generates the OFF signal and outputs the generated OFF signal to first driver 30. As a result, first driver becomes unusable again. The end signal obtained in Step S24 is an example of first status information.

In Step S25, task instruction device 20 outputs the OFF signal to first driver 30 used in the first task. However, this is not intended to be limiting. Task instruction device 20 may output the OFF signal to all the drivers (first driver 30 and second driver 40 according to the present embodiment) regardless of the driver used. This eliminates processing performed by task instruction device 20 in Step S25 to determine the driver to which the OFF signal is to be outputted, and thus reduces an amount of processing of task instruction device 20. The OFF signal outputted in Step S25 is an example of the second control signal.

If first driver 30 does not include determiner 33 and task instruction device 20 obtains information about the number of turns counted by pulse counter 32, determiner 23 determines from this number of turns whether the first task is completed. If determiner 23 determines that the first task is completed, generator 24 obtains, as an end signal of the first task, a signal indicating that the first task is determined as being completed. If this end signal is obtained, task instruction device 20 may perform Step S25.

By obtaining the OFF signal from task instruction device 20 via communicator 31, first driver 30 becomes unusable again.

As a result of execution of Steps S22 to S25 described above, the task of step 1 is completed. Next, a case of performing a task of step 2 is described.

Task instruction device 20 next outputs task details of step 2 to output system 60 (S26). To be more specific, task instruction device 20 outputs task instruction image P corresponding to the task details of step 2, to output system 60 via communicator 21. The task of step 2 is an example of the third task.

Output system 60 obtains the task details of step 2 from task instruction device 20 (S63), and then outputs the obtained task details of step 2 (S64). For example, output system 60 changes the details to be outputted, from the task details of step 1 to the task details of step 2. At least one of viewing or listening to the task details of step 2 outputted from output system 60 enables the worker to understand the task details of step 2, for example.

Next, task instruction device 20 generates a signal to turn on (that is, the ON signal) second driver 40 to be used in the task of step 2 and then outputs this ON signal (S27). To be more specific, generator 24 generates the ON signal to enable the driver and outputs this ON signal via communicator 21. In Step S27, the ON signal is outputted only to second driver 40 out of first driver 30 and second driver 40. More specifically, the ON signal is not outputted to first driver 30 in Step S27 and thus first driver 30 remains unusable while step 2 is being performed. The ON signal outputted in Step S27 is an example of the third control signal.

Obtaining the ON signal, second driver 40 becomes usable. In response to an operation of the worker, second driver 40 fastens the second screw (S41). At this time, first driver 30 is unusable and thus the worker is unable to mistakenly fasten the first screw with first driver 30 in Step S41.

Pulse counter 42 counts the number of turns made by second driver 40 in the fastening of the second screw. Then, if the number of turns counted by pulse counter 42 is within the second reference number of turns corresponding to the second screw, determiner 43 determines that the second screw is fastened. For example, a plurality of second screws are fastened in the third task, determiner 43 makes this determination about the number of turns for each of the plurality of second screws. If determining that the number of turns is within the second reference number of turns for each of the plurality of second screws, determiner 43 determines that the second screws are fastened. More specifically, if all the numbers of turns of the plurality of second screws (three second screws in the example illustrated in FIG. 2) used in the third task are within the second reference number of turns, determiner 43 determines that the third task is completed.

If determining that the third task is completed, determiner 43 outputs an end signal indicating that the third task is completed, to task instruction device 20 via communicator 41 (S42). The end signal may include results of detection of an increase in torque, a start of turning, and an end of turning detected by detector 44.

If obtaining the end signal from second driver 40 (S28), task instruction device 20 generates the OFF signal to make second driver 40 unusable and then outputs this signal (S29). As a result, second driver 40 becomes unusable again. In Step S29, task instruction device 20 may output the OFF signal to all the drivers (first driver 30 and second driver 40 according to the present embodiment) regardless of the driver used. The end signal obtained in Step S28 is an example of second status information. The OFF signal outputted in Step S29 is an example of the fourth control signal.

By obtaining the OFF signal from task instruction device 20 via communicator 41, second driver 40 becomes unusable again.

As described above, if the plurality of screw fastening tasks including the first task and the third task are performed, task instruction device 20 enables only the driver (first driver 30, for example) to be used in the task (the first task, for example). Moreover, task instruction device 20 disables the other driver (at least one driver including second driver 40, for example) included in task instruction system 10. This can prevent the plurality of screw fastening tasks from being performed by an incorrect procedure.

Next, the following describes a case where the second task, which is performed without first driver 30 and second driver 40, is performed.

As illustrated in FIG. 5, task instruction device 20 outputs task details of step 3 after Step S29 (S121). Output system 60 obtains the task details of step 3 from task instruction device 20 (S161), and then outputs the obtained task details of step 3 (S162).

Here, the ON signal is not outputted to first driver 30 and second driver 40 after Step S121. Thus, first driver 30 and second driver 40 remain unusable while a task of step 3 is being performed. The task of step 3 is an example of the second task.

Sensor 50 senses the task of step 3 performed by the worker (S151), and determines whether the task of step 3 is completed on the basis of a result of the sensing. If determining that the task of step 3 is completed, sensor 50 outputs, as an end signal, a signal indicating that the task of step 3 is completed to task instruction device 20 (S152).

If obtaining the end signal from sensor 50 (S122), task instruction device 20 outputs task details of step 4 to output system 60 (S123). If sensor 50 does not have the function of determining on the basis of the result of the sensing whether the task of step 3 is completed, determiner 23 may obtain the result of the sensing as status information from sensor 50 and then determine on the basis of the obtained result of the sensing whether the task of step 3 is completed. If determiner 23 determines that the task of step 3 is completed, generator 24 may obtain, as an end signal of the task of step 3, a signal indicating that the task of step 3 is determined as being completed. If obtaining this end signal, a procedure from Step S123 may be performed.

Output system 60 obtains task details of step 4 from task instruction device 20 (S163), and then outputs the obtained task details of step 4 (S164).

Next, task instruction device 20 generates the ON signal to enable first driver 30 that is to be used in a task of step 4, and then outputs this ON signal (S124). In Step S124, the ON signal is outputted only to first driver 30 out of first driver 30 and second driver 40. More specifically, the ON signal is not outputted to second driver 40 in Step S124 and thus second driver 40 remains unusable while the task of step 4 is being performed. The task of step 4 is an example of the fourth task.

As described above, task instruction device 20 further controls the usable and unusable states of the drivers on the basis of the details of the tasks in addition to providing the task instructions to the worker. Assume that the plurality of tasks to be performed include a task performed with a driver that is state-switchable between usable and unusable (such as the first, third, and fourth tasks) and a task performed without the driver (such as the second task). In this case, task instruction device 20 disables all of the at least one driver (first driver 30 and second driver 40, for example) included in task instruction system 10, for the task performed without the driver. Thus, task instruction device 20 can prevent one worker from performing the task with the driver and the task without the driver by an incorrect procedure. Hence, task instruction device 20 enables the worker to perform a series of tasks including screw fastening and a task other than the screw fastening by a correct task procedure.

For example, assume that the screw fastening with the driver (such as the first, third, and fourth tasks) and the task without the driver (such as the second task) are to be performed. In this case, task instruction device 20 may disable all of the at least one driver (first driver 30 and second driver 40, for example) included in task instruction system 10, for the task performed without the driver.

Each of Steps S24, S28, and S122 is an example of obtaining. Each of Steps S25, S29, and S124 is an example of generating and outputting.

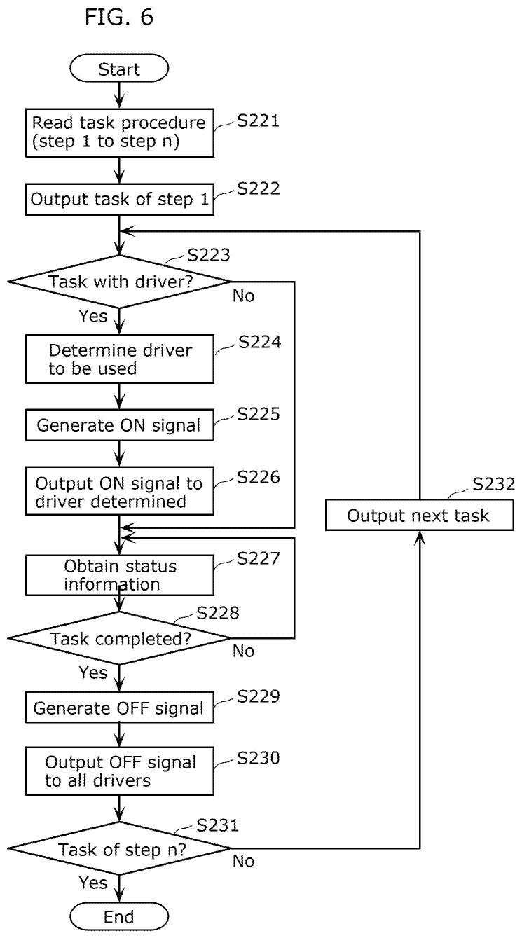

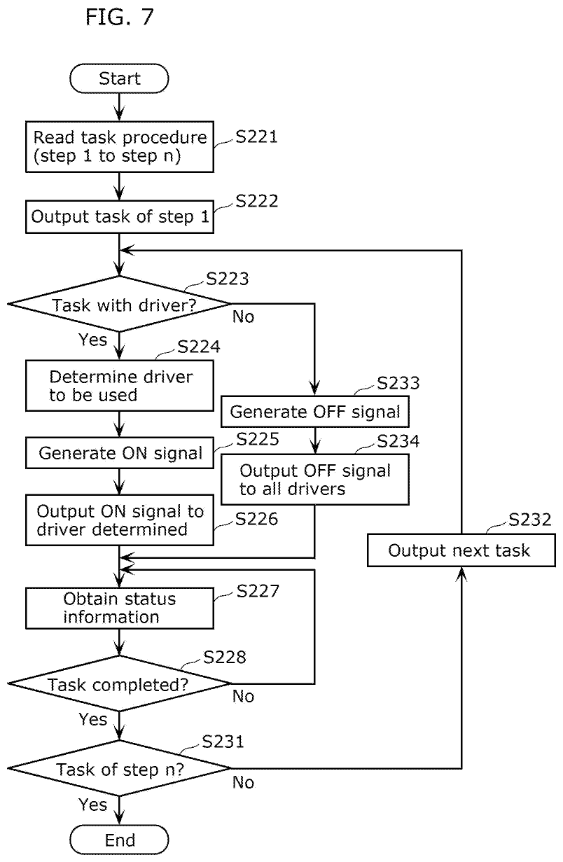

Hereinafter, the operation of task instruction device 20 is described in more detail, with reference to FIG. 6 and FIG. 7. FIG. 6 is a flowchart illustrating an example of an operation performed by task instruction device 20 according to Embodiment. Each of FIG. 6 and FIG. 7 illustrates a case where task instruction device 20 determines on the basis of the screw fastening information obtained from the driver whether the task with the driver is completed. Note that the task procedure includes step 1 to step n.

As illustrated in FIG. 6, task instruction device 20 reads the task procedure (S221). Step S221 corresponds to Step S21 of FIG. 5. Then, task instruction device 20 causes output system 60 to output the task of step 1 included in the read task procedure (S222). Step S222 corresponds to Step S22 of FIG. 5. The task of step 1 is the first task, for example. Before causing output system 60 to output the task of step 1 in Step S222, task instruction device 20 may output the OFF signal to all of the plurality of drivers included in task instruction system 10.

Next, task instruction device 20 determines whether a next task is to be performed with a driver (S223). For example, determiner 23 makes this determination by reference to task table T stored in memory 25. If determining that the next task is to be performed with a driver (Yes in S223), determiner 23 determines the driver that is to be used in the next task (S224). For example, determiner 23 determines the driver that is to be used in the task of step 1 from among the plurality of drivers, by reference to task table T. If the plurality of tasks are performed by the worker using only one driver, Step S224 may be omitted.

Generator 24 generates the ON signal to be outputted to the driver determined as a result of the determination made by determiner 23 (S225). Then, generator 24 outputs the generated ON signal to the driver determined (S226). Generator 24 outputs the generated ON signal only to the driver to be used in the next task (that is, only one driver among the plurality of drivers). As a result, for the next task, only the driver to be used in this task becomes usable. Steps S225 and S226 correspond to Steps S23 and S27 of FIG. 5 and to Step S124 of FIG. 5.

If determining that the next task is performed without a driver (No in S223), determiner 23 proceeds to Step S227 without outputting the ON signal to any of the plurality of drivers.

Next, communicator 21 obtains status information indicating a status of the task currently being performed by the worker (S227). For a task with a driver, the status information includes screw fastening information, for example. The status information may include the end signal indicating that the driver determines that the task is completed. For a task without a driver, the status information includes a result of sensing this task, for example.

The timing of obtaining the status information is not intended to be particularly limiting. The status information may be obtained sequentially during the task or at every predetermined timing during the task. If the status information includes the end signal, the status information may be obtained after the completion of the task.

Determiner 23 determines whether the current task is completed, on the basis of the status information obtained in Step S227 (S228). If the current task is performed with the driver, determiner 23 may determine whether the current task is completed on the basis of the screw fastening information obtained from the driver. Alternatively, determiner 23 may determine whether the current task is completed, by obtaining, from the driver, the end signal indicating that the screw fastening is completed. Or, determiner 23 may determine whether the current task is completed, by obtaining an operation performed by the worker to indicate that the current task is completed. Here, the operation performed by the worker to indicate that the current task is completed (such as an operation performed on the footswitch) is an example of the end signal.

If determiner 23 determines that the current task is completed (Yes in S228), generator 24 generates the OFF signal (S229). Then, generator 24 outputs the generated OFF signal to all the drivers, for example (S230). Steps S229 and S230 correspond to Steps S25 and S29 of FIG. 5. In Step S230, the OFF signal may be outputted only to the driver to which the ON signal was outputted in Step S226. If the determination is “No” in S223, Steps S229 and S230 may be omitted.

Determining “Yes” in Step S228 by determiner 23 is included in obtaining the end signal by task instruction device 20.

If determiner 23 determines that the current task is not completed (No in S228), obtaining the screw fastening information or the result of sensing continues. If the end signal is not obtained even after a predetermined period of time following the output of the ON signal in Step S226 (if the determination is not “Yes” in Step S228, for example), determiner 23 may determine that an anomaly is occurring to the current task. The predetermined period of time may be determined on the basis of the standard time of the current task.

Next, determiner 23 determines whether the current task is of step n (S231). Determiner 23 determines by reference to task table T whether the series of tasks performed by the worker is completed. If determining that the current task is of step n (Yes in S231), determiner 23 ends the task instruction operation. If determining “Yes” in Step S231, determiner 23 may cause display device 61 to display the result of the task including the task time illustrated in FIG. 3D

If determining that the current task is not of step n (No in S231), determiner 23 causes output system 60 to output a next task from the read task procedure (S232). Then, Steps S223 to S230 are repeated until the determination becomes “Yes” in Step S231. Depending on the skill level of the worker, Step S232 may be omitted at least once out of multiple times this step is repeated.

Step S227 is an example of obtaining. Each of Steps S225 and S229 is an example of generating. Each of Steps S226 and 230 is an example of outputting.

FIG. 6 illustrates a case where communicator 21 obtains the end signal. However, communicator 21 may obtain a start signal. For example, if obtaining via communicator 21 a signal indicating that the worker performs an operation to start a next task after determining “No” in Step S231, determiner 23 may determine, on the basis of this signal as the start signal, that a procedure from Step S232 is to be started.

The operation of task instruction device 20 is not limited to the above if the plurality of drivers to be used for the plurality of tasks are controllable. More specifically, task instruction device 20 may enable only the driver that is to be used for a task among the plurality of tasks and disable all the drivers for a task performed without a driver. FIG. 7 is a flowchart illustrating another example of an operation performed by task instruction device 20 according to Embodiment. The same steps as in FIG. 6 are assigned the same step numbers as in FIG. 6 and description of these steps may be simplified or omitted. In the flowchart of FIG. 7, Steps S229 and S230 of the flowchart in FIG. 6 are eliminated, and Steps S233 and S234 are added.

As illustrated in FIG. 7, if determiner 23 determines “No” in Step S223, generator 24 generates the OFF signal (S233). Then, generator 24 outputs the generated OFF signal to all the drivers (S234). As a result, all the drivers become unusable for the task performed without the driver. In Step S226, the ON signal is outputted only to the driver to be used. As a result, only the driver to be used in the task becomes usable.

### [4. Advantageous Effects Etc.]

As described above, task instruction device 20 (an example of the task assistance device) assists a worker who performs a plurality of tasks by a predetermined task procedure. The plurality of tasks include: a first task performed by the worker with first driver 30 (an example of the first tool) that is state-switchable between usable and unusable; and a second task performed by the worker without first driver 30. Task instruction device 20 includes: communication 21 (an example of the obtainer) that obtains a start signal indicating a start and an end signal indicating an end, for each of the plurality of tasks; generator 24 that generates a first control signal that makes first driver 30 usable if communication 21 obtains at least one of the start signal of the first task or the end signal of the second task, and generates a second control signal that makes first driver 30 unusable if communicator 21 obtains at least one of the end signal of the first task or the start signal of the second task; and communicator 21 (an example of the output unit) that outputs the first control signal and the second control signal generated by generator 24 to first driver 30.

Thus, first driver 30 becomes usable only for the first task that is performed with first driver 30, and then becomes unusable for the second task. As a result, the worker is prevented from making a task error, such as performing the first and second tasks by an incorrect procedure. Hence, task instruction device 20 prevents the worker from making a task error in performing the task with first driver 30 and the task without first driver 30.

Here, task instruction device 20 (an example of the task assistance device) may assist a worker who performs a plurality of tasks by a predetermined task procedure. The plurality of tasks may include: a first task performed by the worker with first driver 30 (an example of the first tool) that is operable by power; and a second task performed by the worker without a tool, including first driver 30, operable by power. Task instruction device 20 may include: communication 21 (an example of the obtainer) that obtains a start signal indicating a start and an end signal indicating an end, for each of the plurality of tasks; generator 24 that generates a first control signal that makes first driver 30 usable if communication 21 obtains at least one of the start signal of the first task or the end signal of the second task, and generates a second control signal that makes first driver 30 unusable if communicator 21 obtains at least one of the end signal of the first task or the start signal of the second task; and communicator 21 (an example of the output unit) that outputs the first control signal and the second control signal generated by generator 24 to first driver 30.

This device achieves the same advantageous effects as task instruction device 20 described above. To be more specific, task instruction device 20 prevents the worker from making a task error in performing the task with first driver 30 and the task without first driver 30.

Moreover, communicator 21 obtains, from first driver 30, at least one of the start signal of the first task or the end signal of the first task. Then, generator 24 generates at least one of the first control signal or the second control signal if at least one of the start signal or the end signal is obtained from first driver 30.

Thus, the signal indicating whether the task is completed is received from the driver. This eliminates the need for a sensor or a switch that determines whether the task of the driver is completed, and thereby simplifies the device configuration.

Furthermore, the plurality of tasks include a third task performed by the worker with second driver 40 (an example of the second tool) that is state-switchable between usable and unusable and that is different from first driver 30. Communicator 21 further obtains, from second driver 40, at least one of the start signal of the third task or the end signal of the third task. Generator 24 generates a third control signal that makes only second driver 40 usable out of first driver 30 and second driver 40 if communicator 21 obtains the start signal of the third task. Generator 24 generates a fourth control signal that makes first driver 30 and second driver 40 unusable if communicator 21 obtains the end signal of the third task.

Thus, for a task included the plurality of tasks performed with at least two drivers, task instruction device 20 is capable of enabling only the driver that is to be used for the task, among the at least two drivers. Hence, task instruction device 20 prevents the plurality of tasks, performed with the at least two drivers, from being performed by an incorrect procedure. For example, if the first task, the third task, and the second task are performed in this order, both first driver 30 and second driver 40 become unusable during the second task. Thus, task instruction device 20 prevents the worker from making an error in following the task procedure, such as forgetting the second task and mistakenly performing the third task after the first task.

Moreover, the plurality of tasks include a third task performed by the worker with second driver 40 (an example of the second tool) that is operable by power and different from first driver 30. Communicator 21 further obtains, from second driver 40, at least one of the start signal of the third task or the end signal of the third task. Generator 24 generates a third control signal that makes only second driver 40 usable out of first driver 30 and second driver 40 if communicator 21 obtains the start signal of the third task. Generator 24 generates a fourth control signal that makes first driver 30 and second driver 40 unusable if communicator 21 obtains the end signal of the third task.

This achieves the same advantageous effects as task instruction device 20 described above. To be more specific, an error in following the task procedure can be prevented.

Task instruction device 20 further includes determiner 23 (an example of the first determiner) that determines whether the first task is completed, on the basis of first status information indicating a status of the first task obtained from first driver 30. Generator 24 (an example of the obtainer) obtains, as the end signal of the first task from determiner 23, a signal indicating that determiner 23 determines that the first task is completed.

Thus, even if the driver does not have the function of determining whether the task is completed, task instruction device 20 is capable of making this determination. More specifically, even if the driver does not have the function of making the determination, task instruction device 20 is capable of preventing a task error from occurring. Moreover, this case reduces restrictions on the function of the driver to be used and thereby enlarges a choice of drivers connected to task instruction device 20. A low-priced product including a driver with no determination function reduces the cost of task instruction system 10, for example.

Moreover, the plurality of tasks include a third task performed by the worker with second driver 40 that is state-switchable between usable and unusable and that is different from first driver 30. Determiner 23 further determines whether the third task is completed, on the basis of second status information indicating a status of the third task obtained from second driver 40. Generator 24 generates a third control signal that makes only second driver 40 usable out of first driver 30 and second driver 40 if obtaining the start signal of the third task. Generator 24 generates a fourth control signal that makes first driver 30 and second driver 40 unusable if obtaining the end signal of the third task from determiner 23.

Thus, for a task included the plurality of tasks performed with at least two drivers, task instruction device 20 is capable of enabling only the driver that is to be used for the task, among the at least two drivers. Hence, task instruction device 20 prevents the plurality of tasks, performed with the at least two drivers, from being performed by an incorrect procedure.

Furthermore, the plurality of tasks include a third task performed by the worker with second driver 40 that is operable by power and that is different from first driver 30. Determiner 23 further determines whether the third task is completed, on the basis of second status information indicating a status of the third task obtained from second driver 40. Generator 24 generates a third control signal that makes only second driver 40 usable out of first driver 30 and second driver 40 if obtaining the start signal of the third task. Generator 24 generates a fourth control signal that makes first driver 30 and second driver 40 unusable if obtaining the end signal of the third task from determiner 23.

This achieves the same advantageous effects as task instruction device 20 described above. To be more specific, the plurality of tasks, performed with a plurality of drivers, are prevented from being performed by an incorrect procedure.

Moreover, the first tool is first driver 30 used in first screw fastening, and the second tool is second driver 40 used in second screw fastening. Determiner 23 determines whether the first task is completed by comparing a first reference number of turns of first driver 30 that indicates completion of the first screw fastening with a total number of turns of first driver 30 based on the first status information. Determiner 23 determines whether the third task is completed by comparing a second reference number of turns of second driver 40 that indicates completion of the second screw fastening with a total number of turns of second driver 40 based on the second status information indicating the status of the third task obtained from second driver 40.

Thus, if the tool is a driver, task instruction device 20 easily determines whether the task is completed by comparing the number of turns of the driver with the reference number of turns.

Furthermore, communicator 21 further obtains, from a sensor that performs sensing on the second task, a result of the sensing. Task instruction device 20 further includes determiner 23 (an example of the second determiner) that determines on the basis of the result of the sensing whether the second task is completed.

Thus, on the basis of the result of the sensing by sensor 50, task instruction device 20 obtains whether the task performed without the tool (such as the driver) is completed. More specifically, task instruction device 20 obtains the completion of the task performed without the tool, without relying on an operation performed by the worker. This can reduce a load on the worker. Hence, convenience of task instruction device 20 is enhanced.

Moreover, task instruction device 20 further includes generator 24 (an example of a warning issuer) that issues a signal to warn the worker if another task among the plurality of tasks is started before a current task is completed.

Thus, an external output device (for example, display device 61) informs the worker of an occurrence of a task error. Hence, task instruction device 20 informs the worker of the occurrence of the task error early. Moreover, task instruction image P displayed on display device 61 by task instruction device 20 allows the worker to easily view a correct task. Thus, the worker can smoothly perform a repair task. For the repair task, task instruction device 20 may cause output system 60 to output a task instruction for this repair task.

Furthermore, the first control signal enables first driver 30 to operate, and the second control signal disables first driver 30 from operating.

Thus, for the first task, task instruction device 20 performs control to enable only first driver 30 that is used in the first task, in response to an operation performed on first driver 30 by the worker. Even if the worker tries to use first driver 30 in the second task, first driver 30 does not operate. Thus, an occurrence of a task error is prevented by switching the state of first driver 30 between usable and unusable.

As described above, a task instruction method used by task instruction device 20 is a task assistance method that assists a worker who performs a plurality of tasks by a predetermined task procedure. The plurality of tasks include: a first task performed by the worker with first driver 30 (an example of the tool) that is state-switchable between usable and unusable; and a second task performed by the worker without first driver 30. The task instruction method includes: obtaining a start signal indicating a start and an end signal indicating an end, for each of the plurality of tasks (Steps S24, S28, S122, and S227); generating a first control signal that makes first driver 30 usable if at least one of the start signal of the first task or the end signal of the second task is obtained in the obtaining, and a second control signal that makes first driver 30 unusable if at least one of the end signal of the first task or the start signal of the second task is obtained in the obtaining (Steps S25, S29, S124, S225, and S229); and outputting the first control signal and the second control signal generated in the generating to first driver 30 (Steps S25, S29, S124, S226, and S230). Moreover, a program causes a computer to execute the task instruction method described above.

This achieves the same advantageous effects as task instruction device 20 described above.

Note that a task instruction method used by task instruction device 20 may be a task assistance method that assists a worker who performs a plurality of tasks by a predetermined task procedure. The plurality of tasks may include a first task performed by the worker with first driver 30 (an example of a tool) that is operable by power; and a second task performed by the worker without first driver 30. The task instruction method may include: obtaining a start signal indicating a start and an end signal indicating an end, for each of the plurality of tasks (Steps S24, S28, S122, and S227); generating a first control signal that makes first driver 30 usable if at least one of the start signal of the first task or the end signal of the second task is obtained in the obtaining, and a second control signal that makes first driver 30 unusable if at least one of the end signal of the first task or the start signal of the second task is obtained in the obtaining (Steps S25, S29, S124, S225, and S229); and outputting the first control signal and the second control signal generated in the generating to first driver 30 (Steps S25, S29, S124, S226, and S230). Moreover, a program may cause a computer to execute the task instruction method described above.

### OTHER EMBODIMENTS

Although Embodiment has been described thus far, the present invention is not limited to Embodiment described above.

For example, Embodiment describes a case where the determiner of the task instruction device determines, on the basis of the screw fastening information obtained from the first or second driver, whether the task is completed. However, this is not intended to be limiting. The determiner may obtain, from the sensor (such as a camera), a captured image showing that the worker is fastening the screw with the driver (this image is an example of the status information). Then, the determiner may analyze the obtained image to determine whether the screw fastening is completed.

Embodiment describes the screw fastening performed with a tool like a driver, as an example of a task performed with a tool. However, this is not intended to be limiting. A process performed with a tool may be fastening of a bolt or a nut with a tool. Here, each of the bolt and the nut is an example of the fastener member.

The tool according to Embodiment may be provided with an operating section (such as a button) for outputting a signal indicating a start of a task to the task instruction device. Before starting a task with the tool, the worker operates this operating section of the tool. In other words, the task instruction device may obtain the start signal from this tool. The output of the ON signal from the task instruction device to the tool enables the tool.

Embodiment describes a case where the tool is a driver. However, this is not intended to be limiting. The tool may be any tool that is communicably connected to the task instruction device, outputs the status information (including the end signal) of a task to the task instruction device, and is controllable in state-switching between usable and unusable in response to a control signal from the task instruction device. For example, the tool may be other than a driver (may be an electric tool, for instance). Alternatively, the tool may be a jig (such as a test jig).

Embodiment describes a case where the task instruction device is connected only to the drivers as the example of the tool. However, the task instruction device may be connected to different kinds of tools. The task instruction device may be connected to at least one kind among drivers, tools other than the drivers, and jigs, for example.

Embodiment describes a case where the determiner of the task instruction device determines, on the basis of the number of turns obtained from the first or second driver, whether the task is completed. However, each of measurers of the first and second drivers may include a torque sensor capable of torque measurement. Then, the determiner may determine, on the basis of a result of the torque measurement instead of or in addition to the number of turns, whether the task is completed. In this case, the task table stored in the memory of the task instruction device includes a reference value of torque. Here, the same applies to each of the determiners included in the first and second drivers.

Embodiment describes a case where the task instruction device is connected to a single display device and a single audio output device. However, this is not intended to be limiting. For example, if the worker performs each of the first, second, and third tasks at a different workbench, a display device and an audio device may be provided for each workbench.

Embodiment describes a case where the task instruction device provides the instructions on the task procedure to the worker via the output system. However, this is not intended to be limiting. For example, the task instruction device may not output the task instructions as illustrated in FIG. 3B to the worker.

Segmentation in the function block diagram illustrated in FIG. 1 is an example. A plurality of function blocks may be implemented as one function block. Alternatively, one function block may be segmented into a plurality of function blocks. Or, part of the function may be relocated to a different function block. Moreover, the functions of the plurality of function blocks having similar functions may be processed in parallel or in a time-sharing manner by a single piece of hardware or software.

The task instruction device according to, for example, Embodiment is implemented by a single device. However, the task instruction device may be implemented by a plurality of devices that are connected to each other.

A method used for communication between the devices included in the task instruction system is not intended to be particularly limiting. Wire or wireless communication may be used between the devices.

Some or all of the structural components included in the task instruction device according to Embodiment may be implemented by a single system large scale integration (system LSI). For example, the task instruction device may include a system LSI including the processors, such as the detector, the determiner, and the generator.

The system LSI is a super multifunctional LSI manufactured by integrating a plurality of components onto a signal chip. To be more specific, the system LSI is a computer system configured with a microprocessor, a read-only memory (ROM), a random-access memory (RAM), and so forth. The ROM stores a computer program. The microprocessor operates according to the computer program, thereby allowing the system LSI to perform the function.

Although the integrated circuit implementing these function blocks is referred to as the LSI here, the integrated circuit may be referred to as an IC, an LSI, a super LSI, or an ultra LSI depending on the scale of integration. A method of implementation of the function blocks using an integrated circuit is not limited to application of an LSI. The function blocks may be implemented by a dedicated circuit or a general purpose processor. It is also possible to use a Field Programmable Gate Array (FPGA) that can be programmed after being manufactured, or a reconfigurable processor in which connection and setting of LSI circuit cells can be reconfigured.

Furthermore, when a circuit integration technology that replaces LSIs comes along owing to advances of the semiconductor technology or to a separate derivative technology, the function blocks should be understandably integrated using that technology. There can be a possibility of adaptation of biotechnology, for example.

An aspect according to the present invention may be achieved by a computer program causing a computer to execute characteristic steps included in a task instruction method. Moreover, an aspect according to the present invention may be achieved by a non-transitory computer-readable recording medium having such a computer program recorded thereon.

Each of the structural components according to Embodiment may be configured in the form of an exclusive hardware product, or may be realized by executing a software program suitable for the structural component. Each of the structural components may be implemented by means of a program executer, such as a CPU or a processor, reading and executing the software program recorded on a recording medium such as a hard disk or a semiconductor memory.

Other embodiments implemented through various changes and modifications conceived by a person of ordinary skill in the art or through a combination of the structural components in different embodiments described above may be included in the scope in an aspect or aspects according to the present invention, unless such changes, modifications, and combination depart from the scope of the present invention.

### REFERENCE SIGNS LIST

10 task instruction system
20 task instruction device (task assistance device)
21 communicator (obtainer, output unit)
22 detector
23 determiner
24 generator
25 memory
30 first driver (first tool)
31, 41 communicator
32, 42 pulse counter
33, 43 determiner
34, 44 detector
40 second driver (second tool)
50 sensor
60 output system
61 display device
62 audio output device
T task table
P task instruction image
p1 task name
p2 precautions
p3 description image
p4 component name
p5 selection image
p6 elapsed-time indication bar
p7 actual performance information
p8 operation image
p9 task list

1. A task assistance device that assists a worker who performs a plurality of tasks by a predetermined task procedure, the plurality of tasks including: a first task performed by the worker with a first tool that is state-switchable between usable and unusable; and a second task performed by the worker without the first tool, the task assistance device comprising:
an obtainer that obtains a start signal indicating a start and an end signal indicating an end, for each of the plurality of tasks;
a generator that generates a first control signal that makes the first tool usable when the obtainer obtains at least one of the start signal of the first task or the end signal of the second task, and generates a second control signal that makes the first tool unusable when the obtainer obtains at least one of the end signal of the first task or the start signal of the second task; and
an output unit that outputs the first control signal and the second control signal generated by the generator to the first tool.

2. The task assistance device according to claim 1,
wherein the obtainer obtains, from the first tool, at least one of the start signal of the first task or the end signal of the first task, and
the generator generates at least one of the first control signal or the second control signal when at least one of the start signal or the end signal is obtained from the first tool.

3. The task assistance device according to claim 2,
wherein the plurality of tasks include a third task performed by the worker with a second tool that is state-switchable between usable and unusable and that is different from the first tool,
the obtainer further obtains, from the second tool, at least one of the start signal of the third task or the end signal of the third task, and
the generator generates a third control signal that makes only the second tool usable out of the first tool and the second tool when the obtainer obtains the start signal of the third task, and generates a fourth control signal that makes the first tool and the second tool unusable when the obtainer obtains the end signal of the third task.

4. The task assistance device according to claim 1, further comprising:
a first determiner that determines whether the first task is completed, on the basis of first status information indicating a status of the first task obtained from the first tool,
wherein the obtainer obtains, as the end signal of the first task from the first determiner, a signal indicating that the first determiner determines that the first task is completed.

5. The task assistance device according to claim 4,
wherein the plurality of tasks include a third task performed by the worker with a second tool that is state-switchable between usable and unusable and that is different from the first tool,
the first determiner further obtains, from the second tool, second status information indicating a status of the third task, and determines on the basis of the second status information obtained whether the third task is completed, and
the generator generates a third control signal that makes only the second tool usable out of the first tool and the second tool when the obtainer obtains the start signal of the third task, and generates a fourth control signal that makes the first tool and the second tool unusable when the obtainer obtains the end signal of the third task from the first determiner.

6. The task assistance device according to claim 5,
wherein the first tool is a first driver used in first screw fastening,
the second tool is a second driver used in second screw fastening, and
the first determiner determines whether the first task is completed by comparing a first reference number of turns of the first driver that indicates completion of the first screw fastening with a total number of turns of the first driver based on the first status information, and determines whether the third task is completed by comparing a second reference number of turns of the second driver that indicates completion of the second screw fastening with a total number of turns of the second driver based on the second status information indicating the status of the third task obtained from the second driver.

7. The task assistance device according to claim 1,
wherein the obtainer further obtains, from a sensor that performs sensing on the second task, a result of the sensing, and
the task assistance device further comprising:
a second determiner that determines on the basis of the result of the sensing whether the second task is completed.

8. The task assistance device according to claim 1, further comprising:
a warning issuer that issues a signal to warn the worker when another task among the plurality of tasks is started before a current task is completed.

9. The task assistance device according to claim 1,
wherein the first control signal enables the first tool to operate, and
the second control signal disables the first tool from operating.

10. A task assistance method of assisting a worker who performs a plurality of tasks by a predetermined task procedure, the plurality of tasks including: a task performed by the worker with a tool that is state-switchable between usable and unusable; and a task performed by the worker without the tool, the task assistance method comprising:
obtaining a start signal indicating a start and an end signal indicating an end, for each of the plurality of tasks;
generating a first control signal that makes the tool usable when at least one of the start signal of the task performed with the tool or the end signal of the task performed without the tool is obtained in the obtaining, and a second control signal that makes the tool unusable when at least one of the end signal of the task performed with the tool or the start signal of the task performed without the tool is obtained in the obtaining; and
outputting the first control signal and the second control signal generated in the generating to the tool.

11. A non-transitory computer-readable recording medium embodied with a computer program, the computer program causing a computer to execute the task assistance method according to claim 10.
